(19) United States
(12) Patent Application Publication
(10) Pub. No.: US 2019/0219470 A1
(43) Pub. Date: Jul. 18, 2019

(54) AIRFLOW SENSOR

(71) Applicant: KYUNGDONG NAVIEN CO., LTD., PYEONGTAEK-SI (KR)

(72) Inventors: Gyo Young CHOO, Seoul (KR); Hyun Ik YANG, Seoul (KR)

(21) Appl. No.: 16/247,647

(22) Filed: Jan. 15, 2019

(30) Foreign Application Priority Data
Jan. 16, 2018 (KR) 10-2018-0005356

(51) Int. Cl. G01L 13/02; G01L 13/06

(52) U.S. Cl. CPC G01L 13/025; G01L 13/06

(57) ABSTRACT

The present disclosure is directed to providing an airflow sensor having an improved structure of an elastic member which is a critical component thereof to reduce a defect rate even during long-term use and improve reliability of airflow sensing so that a boiler is controlled at an accurate air-fuel ratio.

The airflow sensor of the present disclosure includes a case having a first air introduction port connected to one side of a flow path in which a differential pressure is formed and a second air introduction port connected to the other side of the flow path formed therein, a diaphragm configured to partition the inside of the case into a first space connected to the first air introduction port and a second space connected to the second air introduction port and displaced according to pressure variation of the first space and the second space, an elastic member formed of a plate spring having an elastic force which acts so that the diaphragm is restored to a location before being displaced, an elevation member displaced along with the diaphragm, and a sensing member configured to sense a displacement amount of the elevation member.

### CROSS-REFERENCE TO RELATED APPLICATION

This application claims priority to and the benefit of Korean Patent Application No. 10-2018-0005356, filed on Jan. 16, 2018, the disclosure of which is incorporated herein by reference in its entirety.

### BACKGROUND

### 1. Field of the Invention

The present disclosure relates to an airflow sensor configured to sense whether overpressure occurs or a headwind flows in a boiler flue, and more specifically, to an airflow sensor configured to reduce a defect rate even during long-term use and improve the reliability of airflow sensing so that a boiler is controlled at an accurate air-fuel ratio by improving a structure of an elastic member which is a critical component thereof.

### 2. Discussion of Related Art

Generally, in an apparatus configured to mix air and fuel to combust the fuel, such as a boiler, combustion efficiency is determined according to how accurately a mixture ratio of the air and the fuel is controlled. Accordingly, in order to control an air-fuel ratio in which the air and the fuel are appropriately mixed in the case of the boiler, methods capable of improving the combustion efficiency of the boiler and maximally restraining discharge of harmful gas to prevent environmental pollution by adjusting the number of revolutions of a blower and supplying an accurate amount of fuel in proportion to the pressure of introduced air through a current proportional control type or an air proportional control type as a method of adjusting an operation state of each of the blower configured to supply combustion air and a fuel supplying proportional valve configured to supply the fuel, are suggested.

The current proportional control type is configured so that a supply amount of the combustion air is converted from the number of revolutions of the blower according to a desired heat amount and a current value of a fuel supplying current proportional valve is controlled corresponding to the calculated number of revolutions of the blower to appropriately maintain the air-fuel ratio, and the air proportional control type is configured so that a supply amount of the combustion air is converted from the number of revolutions of the blower according to a desired heat amount and an air proportional valve is automatically opened and closed corresponding to the pressure of the air according to the calculated number of revolutions of the blower to supply an appropriate fuel amount, and thus an amount of the fuel can be automatically adjusted according to an amount of the supplied air to appropriately maintain the air-fuel ratio.

Particularly, in a case of the combustion apparatus such as the boiler, an air amount and a fuel amount necessary for maintaining required rated output should always be accurately supplied, and since an amount of the fuel supplied when general air and the fuel are mixed can be accurately controlled through adjustment of a fuel supplying value, how much an amount of the introduced air is accurately measured and controlled is very important.

Accordingly, a boiler having an airflow sensor capable of measuring a flow rate of air which is introduced has been recently revealed. The prior art is disclosed in Korean Patent Application No 10-0599170 and the like.

The airflow sensor (APS: Air Pressure Sensor) is an apparatus configured to sense whether overpressure occurs or a headwind flows in a boiler flue in order to automatically adjust an amount of air through control of the number of revolutions of a blower and is generally formed in a structure driven by connecting the airflow sensor to the blower of the boiler to use a differential pressure of the air. A coil spring, which is conventionally and mainly used as a critical component of the airflow sensor, serves to adjust a pressure of each of an upper portion and a lower portion of the airflow sensor. However, since a free field (see FIG. 1) dimension defect due to instability of a spring index (a value in which a center diameter is divided by a diameter in FIG. 1) occurs when the airflow sensor, in which the coil spring is mounted, is used for a long time, airflow cannot be accurately sensed, and accordingly, an air-fuel ratio of the boiler cannot be accurately controlled.

The instability of the spring index and the free field dimension defect of the coil spring are caused due to a structural characteristic of the coil spring having weak tensile strength and yield strength and thus causing plastic deformation when used for a long time. Accordingly, development of an airflow sensor having an elastic member having a small defect rate and capable of maintaining tensile strength and yield strength even when elastically deformed over and over according to airflow variation is required by improving a structure of the coil spring mounted in the airflow sensor.

### SUMMARY OF THE INVENTION

The present disclosure is directed to providing an airflow sensor configured to reduce a defect rate even during long-term use and improve reliability of airflow sensing so that a boiler is controlled at an accurate air-fuel ratio by improving a structure of an elastic member which is a critical component thereof.

According to an aspect of the present disclosure, there is provided an airflow sensor including a case having a first air introduction port connected to one side of a flow path in which a differential pressure is formed and a second air introduction port connected to the other side of the flow path formed therein, a diaphragm configured to partition the inside of the case into a first space connected to the first air introduction port and a second space connected to the second air introduction port and displaced according to pressure variation of the first space and the second space, an elastic member formed of a plate spring having an elastic force which acts so that the diaphragm is restored to a location before being displaced, an elevation member displaced along with the diaphragm, and a sensing member configured to sense a displacement amount of the elevation member.

The elastic member may include a displacement part displaced along with the diaphragm, a supporting part seated on the case, and a connection part configured to connect the displacement part and the supporting part.

The displacement part may be formed in a circular shape, a plurality of supporting parts may be provided to be spaced apart from an outer circumference of the displacement part at a predetermined angle interval, one side end of the connection part may be connected to a location spaced apart from an outer side end of the displacement part at a predetermined angle interval, and the other side end of the connection part may be connected to the plurality of supporting parts.

The connection part may be provided between the displacement part and the supporting part in a spiral shape.

A round part may be formed at a portion in which the displacement part and the one side end of the connection part are connected to each other.

The plurality of supporting parts and the plurality of connection parts may each be provided to be greater than or equal to three.

The elevation member may include a supporting plate coupled to one side surface of the diaphragm and a plurality of supporters provided at locations spaced apart from the other side surface of the supporting plate in a circumferential direction and formed to protrude toward the other side, and a plurality of coupling holes to which end portions of the plurality of supporters are coupled may be formed in the displacement part.

A seating supporting part on which the supporting part is seated may be provided in the case and a support protrusion configured to support the supporting part may be provided on the seating supporting part.

An inner side end of the seating supporting part may be formed as an inclined surface to avoid interference with an inner side end of the supporting part.

A magnetic body may be mounted on the elevation member, and the sensing member may include a magnetic sensor configured to sense a magnetic force change of the magnetic body according to displacement of the elevation member.

A magnetic body fixing part in which the magnetic body is mounted may be provided on the elevation member, an elevation guide part configured to guide the magnetic body fixing part so that the magnetic body fixing part is elevated at an accurate location, may be provided in the case, and the sensing member may be provided at one side of the elevation guide part.

### BRIEF DESCRIPTION OF THE DRAWINGS

The above and other objects, features and advantages of the present disclosure will become more apparent to those of ordinary skill in the art by describing in detail exemplary embodiments thereof with reference to the accompanying drawings, in which:

FIG. 1 is a view for describing a spring index of a coil spring and a free field;

FIG. 2 is a perspective view of an airflow sensor according to an embodiment of the present disclosure;

FIG. 3 is a view for describing a structure in which a first air introduction port and a second air introduction port are connected to a flow path in which a differential pressure is formed;

FIG. 4 is an exploded perspective view of FIG. 2;

FIG. 5 is a plan view of an elastic member shown in FIG. 2;

FIG. 6 is an operation state view illustrating a case in which the elastic member is displaced according to variation of airflow;

FIG. 7 is a plan view of FIG. 2

FIG. 8(a) and FIG. 8(b) are a view including FIG. 8(a) which is a cross-sectional view taken along line A-A in FIG. 7 and FIG. 8(b) which is a cross-sectional perspective view;

FIG. 9(a) and FIG. 9(b) are a view including FIG. 9(a) which is a cross-sectional view taken along line B-B in FIG. 7 and FIG. 9(b) which is a cross-sectional perspective view; and

FIG. 10(a) and FIG. 10(b) are a modification of the present disclosure, wherein FIG. 10(a) is a plan view of a case in which the elastic member is seated on a lower case and FIG. 10(b) is a cross-sectional view taken along line C-C in (a).

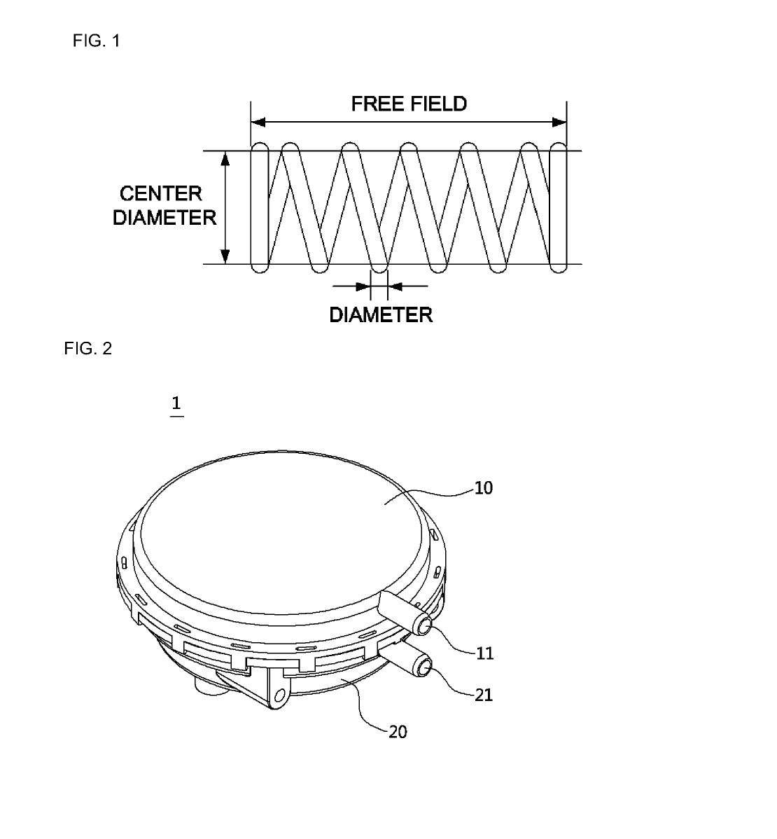

### DETAILED DESCRIPTION OF EXEMPLARY EMBODIMENTS

Hereinafter, a configuration and an action of an embodiment of the present disclosure will be described in detail with reference to the accompanying drawings.

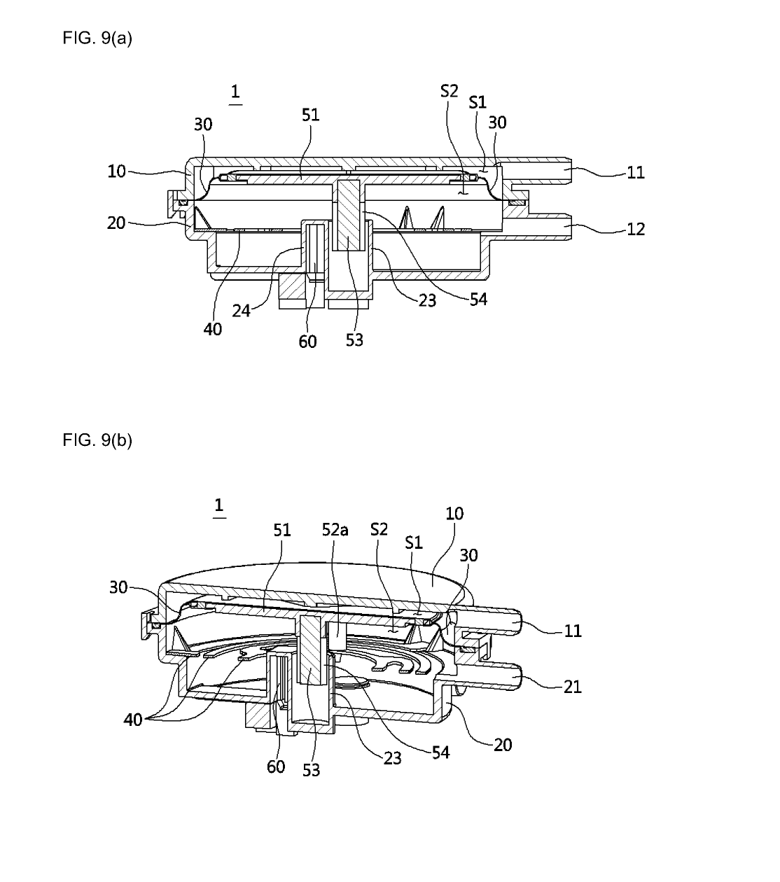

Referring to FIGS. 2 to 4, an airflow sensor 1 of the present disclosure includes cases 10 and 20 respectively having a first air introduction port 11 connected to one side flow path P1 of a flow path P in which a differential pressure is formed and a second air introduction port 21 connected to the other side flow path P2 formed therein, a diaphragm 30 configured to partition the insides of the cases 10 and 20 into a first space S1 connected to the first air introduction port and a second space S2 connected to the second air introduction port 21 and displaced according to pressure variation of the first space S1 (see FIG. 9(a) and FIG. 9(b)) and the second space S2, an elastic member 40 formed of a plate spring having an elastic force which acts so that the diaphragm 30 is restored to a location before being displaced, an elevation member 50 displaced along with the diaphragm 30, and a sensing member 60 configured to sense a displacement amount of the elevation member 50.

The cases 10 and 20 include an upper case 10 having the first air introduction port 11 formed in one side thereof and a lower case 20 having the second air introduction port 21 formed in one side thereof and coupled to a lower portion of the upper case 10.

In the lower case 20, a seating supporting part 22 on which supporting parts (42) 42a, 42b and 42c of the elastic member 40 which will be described below are seated, an elevation guide part 23 configured to guide a magnetic body fixing part 54 of the elevation member 50 so that the magnetic body fixing part 54 is elevated at an accurate location, and a sensing member mounting part 24 to which the sensing member 60 is coupled.

The diaphragm 30 may be formed of a film which is stretchable by an external force according to variation of an air pressure and may be formed of a soft synthetic resin material such as rubber or the like. A border portion of the diaphragm 30 is coupled and fixed to an edge portion of each of the upper case 10 and the lower case 20. A center portion of the diaphragm 30 except the border portion is displaced toward the second space S2 having a relatively smaller air pressure due to a difference between a pressure of air introduced into the first space S1 on the diaphragm 30 through the first air introduction port 11 and a pressure of air introduced into the second space S2 under the diaphragm 30 through the second air introduction port 21.

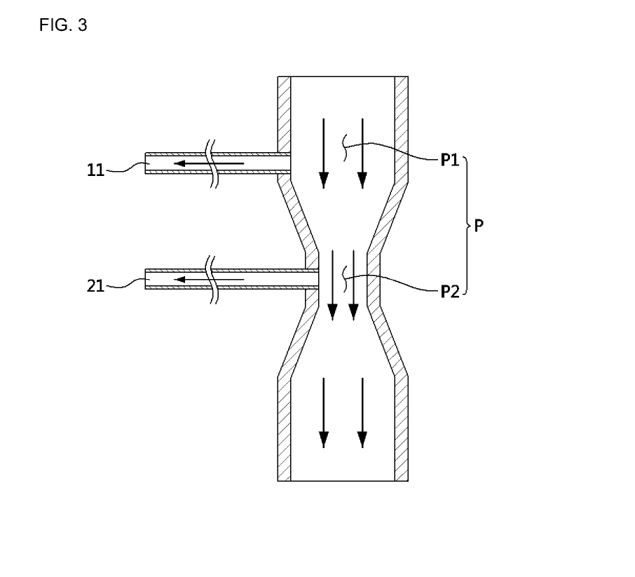

As shown in FIG. 3, the flow paths (P) P1 and P2 through which air flows are formed in a venture structure having a cross-sectional area gradually reduced and expanded again to form the differential pressure on the basis of an air flow direction shown in an arrow, the first air introduction port 11 is connected to one side of the first flow path P1 having a relatively greater cross-sectional area and in which a relatively greater pressure acts on the flow path P, and the second air introduction port 21 of the flow path P is connected to one side of the second flow path P2 having a relatively smaller cross-sectional area and in which a relatively smaller pressure acts on the flow path P.

As described above, when the air flows along the flow path P, the pressure acting on the first flow path P1 is formed to be greater than the pressure acting on the second flow path P2. Accordingly, when the air flows in a direction which is the same as that of the arrow, the pressure of air introduced into the first space S1 through the first air introduction port 11 connected to the first flow path P1 is formed to be greater than the pressure of air introduced into the second space S2 through the second air introduction port 21 connected to the second flow path P2, Accordingly, the diaphragm 30 is displaced in a direction toward the second space S2 when the air pressure acts on the basis of an initial location in which the air pressure does not act.

Further, the displacement amount of the diaphragm 30 is proportional to an amount of the air which flows through the flow paths (P) P1 and P2. That is, when a large amount of air flows through the flow paths (P) P1 and P2, the displacement amount in which the diaphragm 30 moves in a downward direction increases.

The elastic member 40 includes a displacement part 41 displaced along with the diaphragm 30, the supporting parts (42) 42a, 42b and 42c seated on an upper surface of the seating supporting part 22 formed in the lower case 20, and connection parts (43) 43a, 43b and 43c configured to connect the displacement part 41 and the supporting parts (42) 42a, 42b and 42c.

The displacement part 41 is formed in a circular shape. Since an opening 41′ is formed in a center of the displacement part 41, during elevation movement of the displacement part 41, inference with the elevation guide part 23 and the sensing member mounting part 24 provided thereunder may be prevented.

The plurality of supporting parts (42) 42a, 42b and 42c are spaced apart from each other at a predetermined angle interval on an outer circumference of the displacement part 41.

One side ends of the connection parts (43) 43a, 43b and 43c may be connected to locations spaced apart from each other at a predetermined angle interval on an outer side end of the displacement part 41, and the other side ends of the connection parts (43) 43a, 43b and 43c may be connected to the plurality of supporting parts (42) 42a, 42b and 42c. The connection parts (43) 43a, 43b and 43c may each be provided in a spiral shape between the displacement part 41 and the supporting parts (42) 42a, 42b and 42c.

Round parts (44) 44a, 44b and 44c may be formed on portions to which the displacement part 41 and one side ends of the connection parts (43) 43a, 43b and 43c are connected. As the round parts (44) 44a, 44b and 44c are formed, even during repetitive elevation operation of the displacement part 41, since a phenomenon, in which stress is concentrated on portions to which the displacement part 41 and the one side ends of the connection parts (43) 43a, 43b and 43c are connected, may be prevented and the stress is distributed to prevent partial deformation and damage, durability may be improved.

In the embodiment, although an example in which the supporting parts (42) 42a, 42b and 42c include three supporting parts and the connection parts (43) 43a, 43b and 43c include three connection parts is described, the present disclosure is not limited to the above-described number for installation, and each of the number of supporting parts (42) 42a, 42b and 42c and the number of connection parts (43) 43a, 43b and 43c may be greater than or equal to three when the displacement part 41 may be supported to be stably elevated.

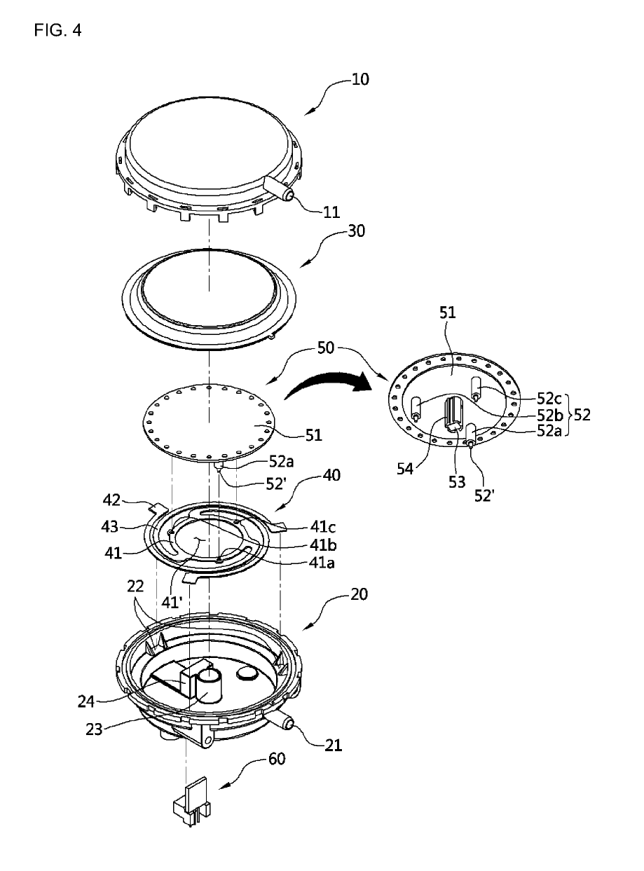

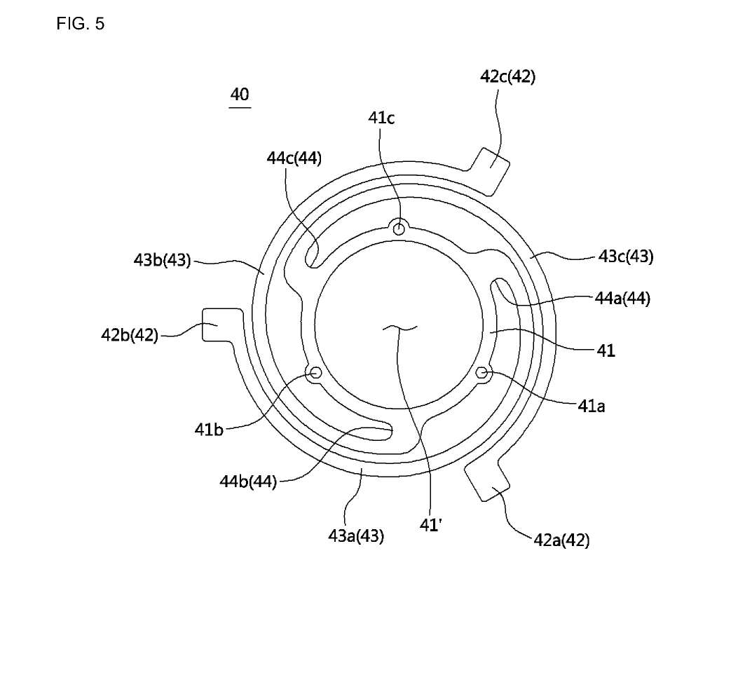

The elevation member 50 is a configured to connect the diaphragm 30 and the elastic member 40, and a case in which the elevation member 50 is viewed from different directions is shown in FIG. 4. The elevation member 50 includes a supporting plate 51 coupled to one side surface of the diaphragm 30 and a plurality of supporters (52) 52a, 52b and 52c disposed at locations spaced apart from each other in a circumferential direction on the other side surface of the supporting plate 51 and formed to protrude toward the other side. A plurality of coupling holes 41a, 41b and 41c to which end portions 52′ of the plurality of supporters (52) 52a, 52b and 52c are coupled may be formed in the displacement part 41. Further, a magnetic body fixing part 54 to which a magnetic body 53 is coupled may be formed on the supporting plate 51.

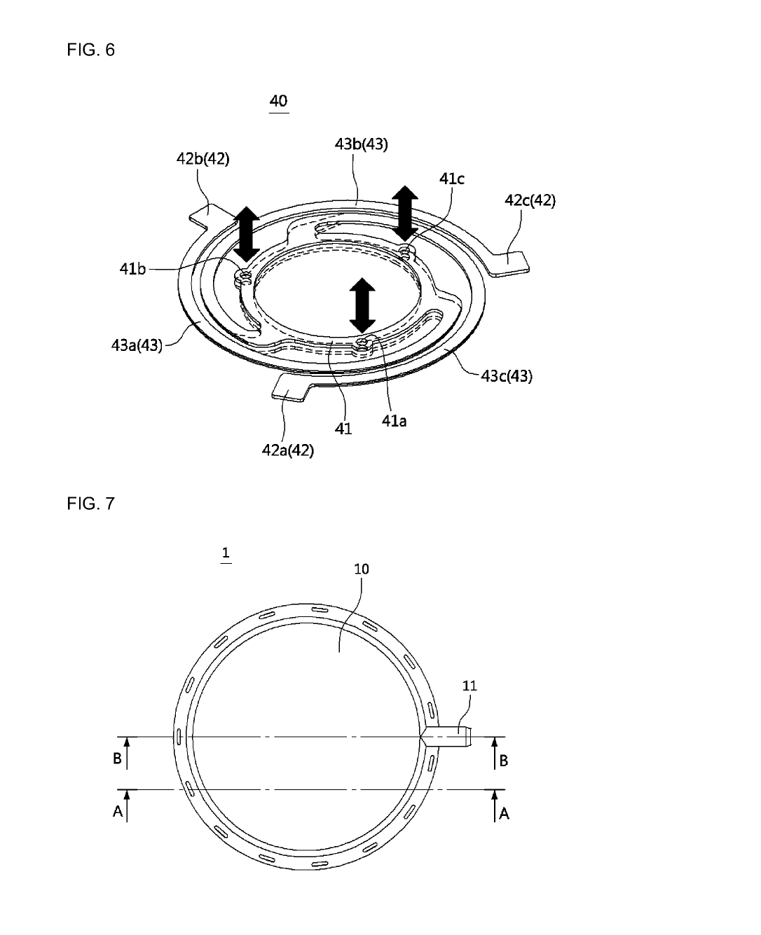

Referring to FIG. 6, as shown by the arrows, when the diaphragm 30 is displaced in proportion to a difference between pressures of the air introduced into the first space S1 and the air introduced into the second space S2, the elevation member 50 connected to the diaphragm 30 is elevated to move, and since the displacement part 41 of the elastic member 40 coupled to lower ends 52′ of the supporters (52) 52a, 52b and 52c of the elevation member 50 through the coupling holes 41a, 41b and 41c is also elastically deformed, and thus an elastic force acts in a direction in which the elevation member 50 is restored to a location before being displaced.

The displacement amount of the elevation member 50 according to displacement of the diaphragm 30 is sensed in the sensing member 60. To this end, the magnetic body 53 may be mounted in the magnetic body fixing part 54 of the elevation member 50, and the sensing member 60 may be formed of a magnetic sensor configured to sense magnetic force variation of the magnetic body 53 according to displacement of the elevation member 50.

On the basis of the displacement amount of the elevation member 50 sensed in the sensing member 60, the amount of the air which flows through the flow path P is calculated and a fuel amount of gas, oil, or the like may be controlled in proportional to the calculated flow amount of the air, and accordingly, the amount of the air and the fuel amount may be precisely controlled to have a predetermined air-fuel ratio according to the rated output demanded in a boiler.

However, the sensing member 60 may be replaced with other various notified sensing means such as an optical sensor having light emitting part and light receiving part, a sensor having a light transmissive film to sense intensity of irradiated light, or the like in addition to the magnetic sensor and thus be modified.

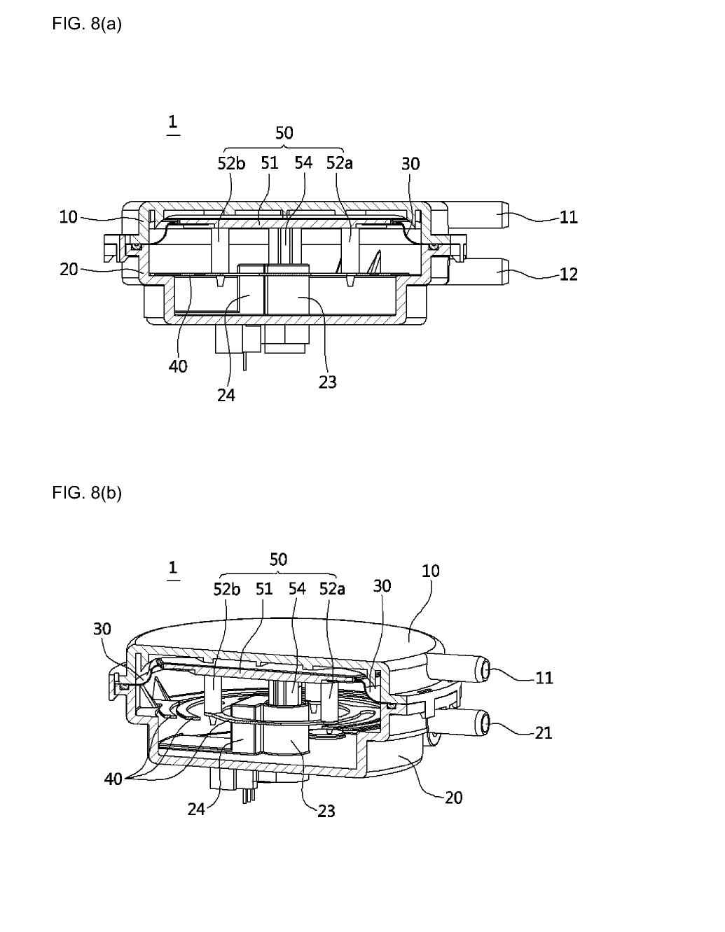

A connection structure between the diaphragm 30, the elevation member 50, and the elastic member 40 is shown in FIG. 7, FIG. 8(a), and FIG. 8(b) and a structure in which the first air introduction port 11 and the first space S1 are connected and a structure in which the second air introduction port 21 and the second space S2 are connected are shown in FIG. 7, FIG. 9(a), and FIG. 9(b).

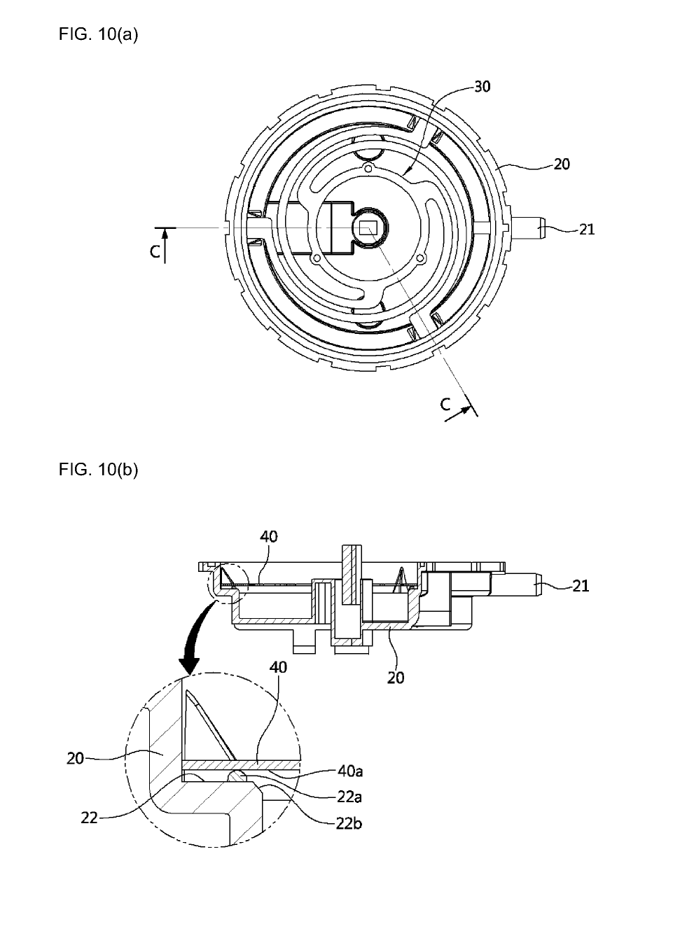

Meanwhile, referring to FIG. 10(a) and FIG. 10(b), as a modification of the present disclosure, the seating supporting part 22, on which the supporting parts (42) 42a, 42b and 42c of the elastic member 40 are seated, may be provided in the lower case 20, and a support protrusion 22a configured to support the supporting parts (42) 42a, 42b and 42c may be provided on the seating supporting part 22. An upper end of the support protrusion 22a may be formed in a round shape to reduce stress loss by minimizing a contact area between the elastic member 40 and the support protrusion 22a and to minimize abrasion of a portion in which the elastic member 40 and the support protrusion 22a come into contact with each other with improving operability of the elastic member 40.

Further, when the elastic member 40 is elastically deformed in a vertical direction according to the variation of the air pressure, an inner side end of the seating supporting part 22 may be formed as an inclined surface 22b configured to prevent abrasion and damage due to interference to avoid interference with a bottom surface 40a of the elastic member 40 and inner side ends of the supporting parts (42) 42a, 42b and 42c.

As described above, in a configuration of the airflow sensor 1 according to the present disclosure, since a plate spring having an improved structure is applied instead of a conventional coil spring, because of a structural characteristic of a plate type material having large tensile strength and yield strength, free field dimension defect due to instability of a spring index which is a problem when the conventional coil spring is applied may be prevented to reduce a defect rate of the elastic member 40 even during long-term use and improve durability of the airflow sensor 1 and reliability of airflow measurement.

Further, since the elastic member 40 includes a plate spring, mass production according to press die manufacture of the plate spring may be performed, and since components of the airflow sensor 1 are easily assembled, an automatized assembly line may be built.

In an airflow sensor according to the present disclosure, since a structure of an elastic member provided to restore a diaphragm displaced by variation of an air pressure to a state before being displaced is changed from a conventional coil spring to a plate spring, a free field dimension defect due to instability of a spring index which is a problem when the conventional coil spring is applied can be prevented to reduce a defect rate of the elastic member even during long-term use, thereby improving durability of the airflow sensor and reliability of airflow sensing.

Further, since the elastic member includes a plate spring, mass production according to press die manufacture of the plate spring can be performed, and since components of the airflow sensor are easily assembled, an automatized assembly line can be built.

As described above, the present disclosure is not limited to the above-described embodiment, it will be apparent to those skilled in the art that the present disclosure may be modified without departing from the spirit of the present disclosure in the claims, and the modification is included in the scope of the present disclosure.

[Description of Reference Numerals]

| | |
|---|---|
| 1: airflow sensor | 10: upper case |
| 11: the first air introduction port | 20: lower case |
| 21: the second air introduction port | 22: seating supporting part |
| 22a: support protrusion | 22b: inclined surface |
| 23: elevation guide part | 24: sensing member mounting part |
| 30: diaphragm | 40: elastic member |
| 41: displacement part | 41a, 41b, 41c: coupling hole |
| 42, 42a, 42b, 42c: supporting part | 43, 43a, 43b, 43c: connection part |
| 44, 44a, 44b, 44c: round part | 50: elevation member |
| 51: supporting plate | 52, 52a, 52b, 52c: supporter |
| 52′: end portion of supporter | 53: magnetic body |
| 60: sensing member | P: flow path |
| P1: the first flow path | P2: the second flow path |
| S1: the first space | S2: the second space |

What is claimed is:

1. An airflow sensor comprising:
a case having a first air introduction port connected to one side of a flow path in which a differential pressure is formed and a second air introduction port connected to the other side of the flow path formed therein;
a diaphragm configured to partition the inside of the case into a first space connected to the first air introduction port and a second space connected to the second air introduction port and displaced according to pressure variation of the first space and the second space;
an elastic member formed of a plate spring having an elastic force which acts so that the diaphragm is restored to a location before being displaced;
an elevation member displaced along with the diaphragm; and
a sensing member configured to sense a displacement amount of the elevation member.

2. The airflow sensor of claim 1, wherein the elastic member includes a displacement part displaced along with the diaphragm, a supporting part seated on the case, and a connection part configured to connect the displacement part and the supporting part.

3. The airflow sensor of claim 2, wherein:
the displacement part is formed in a circular shape;
a plurality of supporting parts are provided to be spaced apart from an outer circumference of the displacement part at a predetermined angle interval;
one side end of the connection part is connected to a location spaced apart from an outer side end of the displacement part at a predetermined angle interval; and
the other side end of the connection part is connected to the plurality of supporting parts.

4. The airflow sensor of claim 3, wherein the connection part is provided between the displacement part and the supporting part in a spiral shape.

5. The airflow sensor of claim 4, wherein a round part is formed at a portion in which the displacement part and the one side end of the connection part are connected to each other.

6. The airflow sensor of claim 3, wherein the plurality of supporting parts and the plurality of connection parts are each provided to be greater than or equal to three.

7. The airflow sensor of claim 2, wherein:
the elevation member includes a supporting plate coupled to one side surface of the diaphragm and a plurality of supporters provided at locations spaced apart from the other side surface of the supporting plate in a circumferential direction and formed to protrude toward the other side; and
a plurality of coupling holes to which end portions of the plurality of supporters are coupled are formed in the displacement part.

8. The airflow sensor of claim 2, wherein:
a seating supporting part on which the supporting part is seated is provided in the case; and
a support protrusion configured to support the supporting part is provided on the seating supporting part.

9. The airflow sensor of claim 8, wherein an inner side end of the seating supporting part is formed as an inclined surface to avoid interference with an inner side end of the supporting part.

10. The airflow sensor of claim 1, wherein:
a magnetic body is mounted on the elevation member; and
the sensing member is formed of a magnetic sensor configured to sense a magnetic force change of the magnetic body according to displacement of the elevation member.

11. The airflow sensor of claim 10, wherein:
a magnetic body fixing part in which the magnetic body is mounted is provided on the elevation member;
an elevation guide part configured to guide the magnetic body fixing part so that the magnetic body fixing part is elevated at an accurate location, is provided in the case; and
the sensing member is provided at one side of the elevation guide part.
